(19) United States
(12) Patent Application Publication
(10) Pub. No.: US 2013/0167485 A1
(43) Pub. Date: Jul. 4, 2013

(54) TIRE PRESSURE SENSOR STORGE UNIT AND METHOD

(71) Applicant: James V. Ireland, Irvine, CA (US)

(72) Inventor: James V. Ireland, Irvine, CA (US)

(21) Appl. No.: 13/338,532

(22) Filed: Dec. 28, 2011

(51) Int. Cl. B65B 5/00; B65D 85/38

(52) U.S. Cl. 53/473; 206/305

(57) ABSTRACT

A tire pressure sensor storage unit and method by which tire pressure sensors which have been removed from the original wheels installed on a motor vehicle are stored. The storage unit is pressurized from a source of gas (e.g., air) so that the tire pressure sensors can be maintained at a pressure corresponding to the normal operating pressure of the tires associated with the wheels from which the sensors have been removed. The tire pressure sensors are located within respective storage chambers of the storage unit. The storage chambers are covered by a flexible, optically-transparent chamber cover that is adapted to permit signals generated by the tire pressure sensors to be transmitted to an onboard computer of the motor vehicle so as to avoid low tire pressure warning messages being sent to the vehicle operator.

### BACKGROUND OF THE INVENTION

1. Field of the Invention

This invention relates to a storage unit adapted to be pressurized with air and to a method for storing and transporting tire pressure sensors within the storage unit after the sensors have been removed from the stock wheels installed on a motor vehicle. Thus, the tire pressure sensors can be held under pressure and conveniently located so as to remain in wireless communication with the onboard computer of the vehicle to thereby prevent the computer from initiating a false low pressure warning.

2.Background Art.

The stock wheels originally installed on a motor vehicle have respective tire pressure sensors which monitor the pressure to which the tires carried by the wheels are inflated. In later model vehicles, the tire pressure sensors communicate with the onboard computer of the motor by way of a wireless path. The sensors transmit signals to the computer which are indicative of the air pressure of the tires. Should the tire pressure drop below a predetermined minimal operating pressure, the vehicle computer will initiate a warning signal to alert the driver of the low pressure condition in order to encourage the driver to add air to his tire to correct the condition.

On occasion, the owner of the motor vehicle may wish to replace the original stock wheels of the vehicle with custom or new wheels. Some wheels are not compatible with the manufacturer's tire pressure sensors. In this case, the owner may choose to remove the tire pressure sensors altogether from the original wheels to enable installation of the custom or new wheels. The sensors are then typically stored in the trunk of the vehicle or relocated to the residence of the vehicle owner.

Should the vehicle owner some day wish to reinstall the original stock wheels in place of the custom or new wheels, he may not be able to find the tire pressure sensors, because of their relatively small size and the passage of a long time. What is even more, once the tire pressure sensors have been disassociated with the stock wheels, they will experience an ambient pressure (rather than a normal tire pressure) and/or be out of range of the vehicle computer. Consequently, the computer may receive signals (or no signal) from the sensors which are indicative of a low air pressure condition or no pressure at all (i.e., a flat). Hence, the vehicle computer may correspondingly initiate a continuous, but false, low pressure warning signal even when the tires carried by the replacement wheels are properly inflated. Not only can the warning signal disturb the driver, but he may mistakenly believe that air must be added to his tires to avoid an unsafe driving condition.

### SUMMARY OF THE INVENTION

A tire pressure sensor storage unit and method are disclosed to prevent the onboard computer of the motor vehicle from initiating the false low pressure warning signal described above should the tire pressure sensors be removed from and relocated with respect to the original stock wheels of the vehicle. The tire pressure sensor storage unit includes a housing having a plurality of (e.g., four) chambers within which respective ones of the tire pressure sensors are located and transported following their removal from the stock wheels. A conventional air supply valve stem is coupled to the storage chambers of the housing of the storage unit. Air is supplied to the housing via the valve stem so that the chambers are pressurized to lie in a range of operating pressures to which the tires carried by the stock wheels are normally inflated. The storage unit and the tire pressure sensors located in the storage compartments thereof can then be transported inside the vehicle at any suitable location thereof including the trunk so as to remain readily accessible.

That is to say, the tire pressure sensor storage unit will be relatively easy to find especially if, at some time in the future, the vehicle owner wishes to retrieve the tire pressure sensors that have been stored within and transported by the storage unit. Having ready access to the tire pressure sensors may be important should the owner elect to replace the custom wheels with the original stock wheels and reinstall the sensors. By virtue of being able to conveniently transport the storage unit inside the vehicle, the tire pressure sensors will be held under pressure within the storage compartments and located in close proximity so as to remain in communication with the vehicle computer. Accordingly, the signals transmitted by the sensors to the computer will be indicative of a normal tire operating pressure to which the chambers of the storage unit have been pressurized. Hence, the computer is not likely to initiate a low pressure warning which may disturb and alarm the driver.

The housing of the tire pressure sensor storage unit includes a hollow cylindrical base which is divided by intersecting walls to form the (e.g., four) storage chambers within which the tire pressure sensors are stored and carried. Extending over top the storage chambers of the base is a disk-like chamber cover that is manufactured from a flexible, transparent material (e.g., Plexiglass) that will not interfere with the signals being transmitted from the pressure sensors to the vehicle computer. The chamber cover is held in place over top the storage chambers by a metallic (e.g., aluminum) cover support that is located above the chamber cover and secured to the base by means of removable fasteners that run through the housing. A resilient ring-like pressure seal surrounds the housing and lies between the base and the chamber cover to maintain the pressure of the storage chambers once air has been delivered to the storage unit to pressurize the storage chambers via the air supply valve stem coupled thereto. The chamber cover and cover support can be disconnected from the base to gain access to the storage chambers so that the tire pressure sensors can be placed therein or retrieved therefrom.

### BRIEF DESCRIPTION OF THE DRAWINGS

FIG. 1 is a perspective view of a tire pressure sensor storage unit with tie pressure sensors stored therein according to a preferred embodiment of the present invention;

FIG. 2 is a top view of the tire pressure sensor storage unit with sensors of FIG. 1;

FIG. 3 is an exploded view of the pressure sensor storage unit;

FIG. 4 is a side view of the tire pressure sensor storage unit; and

FIG. 5 is a cross-section of the tire pressure storage unit taken along lines 4-4 of FIG. 2

### DESCRIPTION OF THE PREFERRED EMBODIMENT

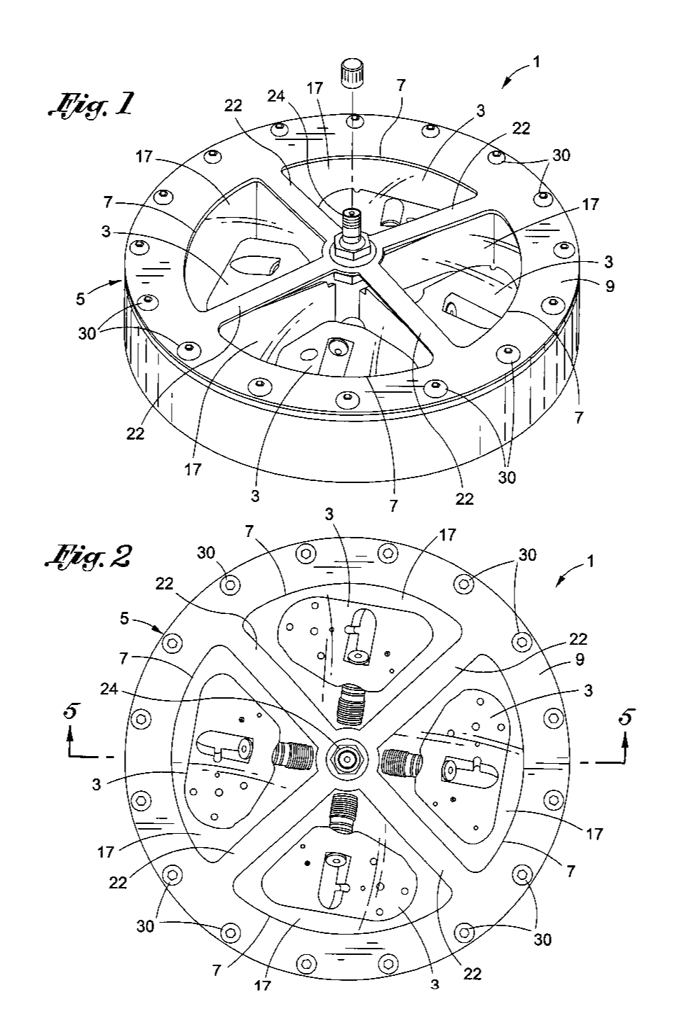

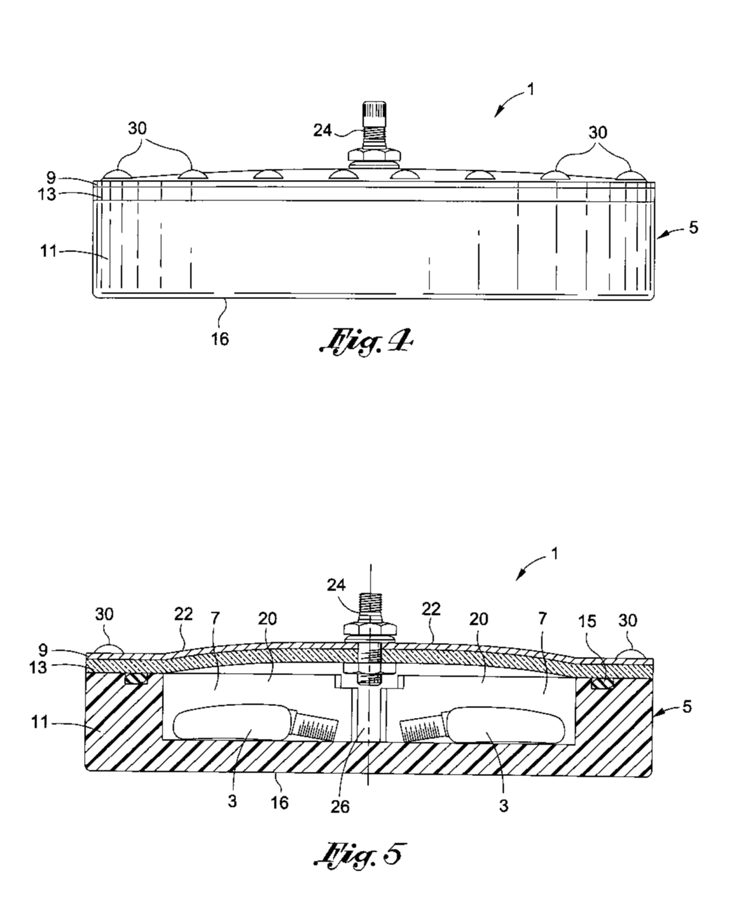

A tire pressure sensor storage unit and method according to a preferred embodiment of this invention are disclosed while referring concurrently to FIGS. 1-5 of the drawings. As will be explained in greater detail hereinafter, the storage unit 1 is especially adapted to be pressurized in order to store and transport under pressure the (e.g., four) tire pressure sensors 3 that have been removed from the original stock wheels of a motor vehicle of the type having an onboard computer that communicates over a wireless path with the tire pressure sensors 3 prior to their removal. The tire pressure sensors 3 are conventional devices which provide the vehicle computer with an indication of the air pressure to which the tires carried by the wheels of the vehicle are inflated. Therefore, details of the tire pressure sensors 3 will not be provided.

The tire pressure sensors 3 might be removed from the wheels of the vehicle for different reasons. By way of example, where the original stock wheels that are sold with the vehicle are replaced by custom wheels, the manufacturer's tire pressure sensors may not be compatible with the replacement wheels. Thus, the sensors may have to be removed to enable the vehicle to accommodate the replacement wheels. Because the tire pressure sensors may later on be returned to the wheels from which they were removed (if the newly-installed wheels are replaced by the original stock wheels), the storage unit 1 of this invention provides a convenient means to store and transport the tire pressure sensors 3 during a period of non-use. To this end, the tire pressure sensor storage unit 1 is advantageously constructed to be able to hold the pressure sensors stored therein under their normal operating pressure.

The tire pressure sensor storage unit 1 is ideal to travel with the vehicle (such as in the trunk) so that the tire pressure sensors 3 will be readily accessible should they be needed in the future. In this regard, it is desirable that the storage unit 1 be located in the vehicle so that the sensors being transported therewith can remain in communication with the vehicle computer. By pressurizing the storage unit 1 (preferably to a pressure lying in a range of pressures between 28-36 psi), the vehicle computer will receive signals from the pressure sensors 3 that indicate that the tires of the vehicle are properly inflated. In other words, the vehicle computer will be unable to detect that the tire pressure sensors 3 have been removed from the original stock wheels and disassociated with the tires intended to be monitored by the sensors.

In the event that the tire pressure sensor storage unit 1 and the tire pressure sensors 3 being transported therewithin were moved out of the range of the vehicle computer, the computer is likely to either lose its signal from the sensors or receive a signal that would initiate a continuous warning to the vehicle operator indicative of a low tire pressure condition or a tire deflation (i.e., a flat). Accordingly, it may be appreciated that by virtue of pressurizing the tire pressure sensor storage unit 1 herein disclosed, the tire pressure sensors 3, following their removal from the stock wheels of the vehicle and relocation to the storage unit, can be held at a normal operating pressure to avoid the transmission of signals from the sensors which would cause the computer to initiate the low tire pressure warnings.

The tire pressure sensor storage unit 1 includes a generally round housing 5 having (four) storage chambers 7 that are sized to receive and carry respective ones of the (four) tire pressure sensors 3. The housing 5 has an upper ring-shaped cover support 9, a lower hollow cylindrical base 11, and an intermediate disk-shaped chamber cover 13. The chamber cover 13 is secured between the upper cover support 9 and the lower base 11 to prevent the loss of pressure to which the chambers 7 will be pressurized. It is to be understood that the precise shapes of the housing 5 as well as the upper cover support 9, lower base 11, and intermediate chamber cover 13 may vary and should not be considered as a limitation of this invention.

The lower base 11 of the housing 5 of storage unit 1 surrounds the storage chambers 7. A resilient (e.g., rubber) sealing ring or grommet 15 (best shown in FIGS. 3 and 5) is located in a groove around the lower base 11 to seal the interface between the lower base 11 and the intermediate chamber cover 13. The bottom 16 of the lower base 11 is closed to coincide with the bottom of the housing 5. The tops of the storage chambers 7 are closed to the atmosphere by the disk-shaped intermediate chamber cover 13. A set of (e.g., four) open windows 17 are formed through the upper cover support 9 so as to be aligned with respective ones of the chambers 7 in which the tire pressure sensors 3 are stored. The chamber cover 13 is both optically transparent and capable of permitting the signals generated by the pressure sensors 3 which are located in the chambers 7 to be received by the vehicle computer without interruption. Prior to pressurization of the storage unit 1, the chamber cover 13 is generally flat. Following pressurization of the storage unit 1, the chamber cover 13 will be forced upwardly against the cover support 9 and assume an arcuate shape (best shown in FIG. 5).

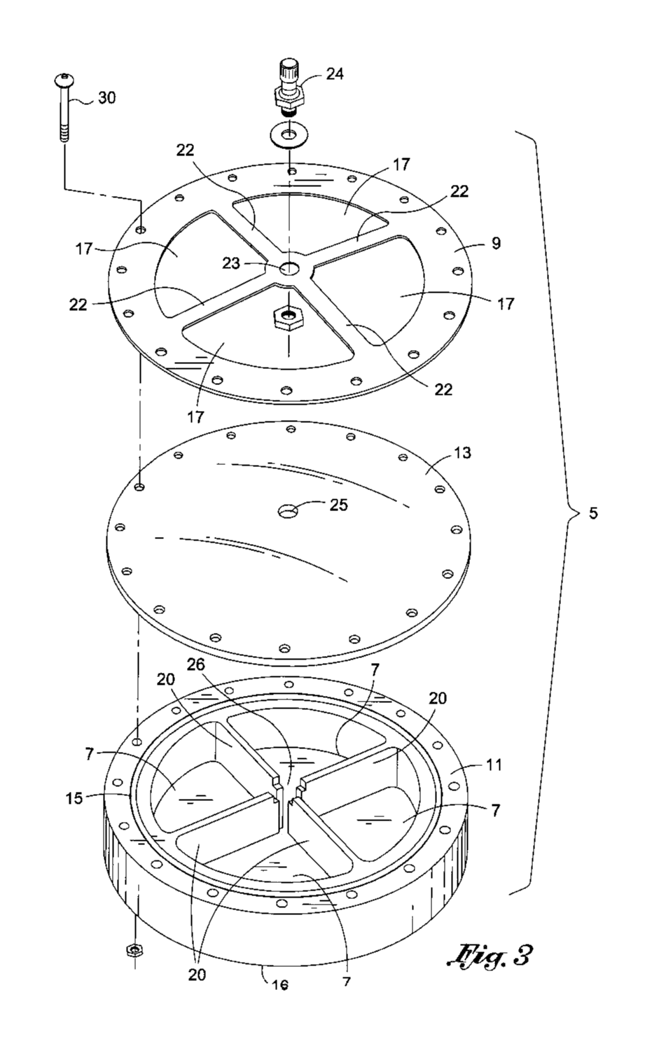

By way of example only and according to the preferred embodiment, the upper cover support 9 of housing 5 is manufactured from metal, such as aircraft grade aluminum, in order to retain and prevent the intermediate chamber cover 13 from expanding and exploding after the storage unit 1 has been pressurized. The lower base 11 of housing 5 is manufactured from an impact-resistant plastic material such as that known commercially as Delrin. The intermediate chamber cover 13 of housing 5 located between the upper cover support 9 and the lower base 11 is manufactured from a clear, flexible material such as Plexiglass. In the assembled configuration of the tire pressure sensor storage unit 1 shown in FIGS. 1 and 2, the tire pressure sensors 3 within the storage chambers 7 are visible through the windows 17 formed in upper cover support 9 and the transparent chamber cover 13 lying above the chambers 7 and between the cover support 9 and the base 11.

Running radially through the tire pressure sensor storage unit I inside the lower hollow cylindrical base 11 of the housing 5 is a set of (e.g., four) dividing walls 20 (best shown in FIG. 3). The dividing walls 20 separate the (four) storage chambers 7 from one another. The walls 20 are preferably spaced apart so that the chambers 7 are of identical size to receive the respective tire pressure sensors 3.

The upper ring-shaped cover support 9 of the housing 5 includes a set of (e.g., four) curved chamber cover retaining arms 22 which are shaped to accommodate the intermediate chamber cover 13 thereagainst once the storage unit 1 is pressurized. The cover retaining arms 22 extend radially across the cover support 9 from the periphery thereof to a central opening 23 (of FIG. 3) at the center of the cover support. The retaining arrns 22 are spaced from one another to establish the open windows 17 through cover support 9. A conventional air supply valve stem 24 is located and retained through the central opening 23 of the cover support 9 so as to be able to communicate with the storage chambers 7 established by the dividing walls 22 within the lower base 11 of the housing 5 of the tire pressure sensor storage unit 1. In this same regard, the valve stem 24 also extends through a central opening 25 (of FIG. 3) that is formed through the intermediate chamber cover 13 and is axially aligned with the central opening 23 of cover support 9.

The tire pressure sensor storage unit 1 as well as each of the tire pressure sensor storage chambers 7 arc pressurized by way of the air supply valve stem 24. That is, a source of air under pressure (not shown) is coupled to the valve stem 24. However, suitable gases (e.g., carbon dioxide) other than air may also be used to pressurize the storage unit 1. The valve stem 24 communicates with each of the storage chambers 7 via spaces 26 established between the chamber dividing walls 20 (best shown in FIGS. 3 and 5).

The upper cover support 9 of the housing 5 of the tire pressure storage unit 1 is detachably connected to the lower base 11 with the intermediate chamber cover 13 sandwiched therebetween by means of a plurality of removable fasteners (e.g., button-head screws) 30 which run through and are spaced from one another around the housing 5. The fasteners 30 may be removed from the storage unit 1 and the upper cover support 9 and intermediate chamber cover 13 disconnected from the lower base 11 in order to gain access to the storage chambers 7 so that the tire pressure sensors 3 can be either placed therein or retrieved therefrom.

1. A method for storing at least one tire pressure sensor that is adapted to sense the pressure to which a tire carried by a wheel is inflated and transmit a signal to a computer which is indicative of the tire pressure sensed, said method comprising the steps of:
removing the at least one tire pressure sensor from the wheel on which the tire is carried;
relocating the tire pressure sensor to a tire pressure sensor storage unit; and
pressurizing said storage unit so that the tire pressure sensor is stored under a pressure greater than ambient pressure.

2. The method recited in claim 1, including the additional step of pressurizing said tire pressure sensor storage unit to a pressure lying in a range of operating pressures to which the tire would be inflated prior to removing the tire pressure sensor from the wheel on which said tire is carried.

3. The method recited in claim 1, including the additional step of transporting said tire pressure sensor storage unit and said tire pressure sensor stored therein so that said sensor ties in range of the computer to enable the signal transmitted by said sensor to be received by said computer.

4. The method recited in claim 1, including the additional step of scaling said tire pressure sensor storage unit from the atmosphere so as to prevent the loss of the pressure to which said storage unit has been pressurized.

5. The method recited in claim 1, including the additional step of locating the tire pressure sensor in a storage chamber of said tire pressure sensor storage unit and covering said storage chamber with a chamber cover that is manufactured from a material adapted to permit the signal transmitted by said sensor to be received by the computer through said chamber cover.

6. The method recited in claim 5, wherein the material from which said chamber cover is manufactured is optically transparent to enable the tire pressure sensor within the storage chamber of said tire pressure sensor storage unit to be seen through said chamber cover.

7. The method recited in claim 5, wherein the material from which said chamber cover is manufactured is flexible so as to be able to bend in response to the pressurization of said tire pressure sensor storage unit.

8. The method recited in claim 5, including the additional step of locating a cover support over said chamber cover to prevent said chamber cover from expanding so as to explode in response to the pressurization of said tire pressure sensor storage unit.

9. The method recited in claim 8, including the additional step of forming an open window through said cover support so that the signal transmitted by said tire pressure sensor is transmitted to the computer through said chamber cover and the open window of said cover support located over said chamber cover.

10. The method recited in claim 5, including the additional steps of positioning a gas supply valve through said chamber cover and said cover support located over said chamber cover so that said valve communicates with the storage chamber of said tire pressure sensor storage unit; and supplying a gas to said storage chamber by way of said valve to pressurize said storage unit and said tire pressure sensor located therewithin.

11. A tire pressure sensor storage unit for storing at least one tire pressure sensor that has been removed from a wheel which carries a tire, said tire pressure sensor adapted to sense the pressure to which the tire is inflated and transmit a signal to a computer which is indicative of the tire pressure sensed prior to the removal of said sensor from the wheel, said storage unit comprising a storage chamber in which to receive said tire pressure sensor and means by which to pressurize said storage unit so that said tire pressure sensor within said storage chamber is held under a pressure greater than ambient pressure.

12. The tire pressure sensor storage unit recited in claim 11, wherein said storage unit is sealed from the atmosphere to prevent a loss of the pressure to which said storage unit has been pressurized and under which said tire pressure sensor is held.

13. The tire pressure sensor storage unit recited in claim 11, further comprising a chamber cover covering the storage chamber of said storage unit and said tire pressure sensor received therein, said chamber cover being manufactured from a material that is adapted to permit the signal transmitted by the pressure sensor received in said storage chamber to be received by the computer through said chamber cover.

14. The tire pressure sensor storage unit recited in claim 13, wherein the material from which said chamber cover is manufactured is optically transparent to enable the tire pressure sensor received within the storage chamber to be seen through said chamber cover.

15. The tire pressure sensor storage unit recited in claim 14, wherein the optically-transparent material from which said chamber cover is manufactured is flexible so as to be able to bend in response to the pressurization of said storage unit.

16. The tire pressure sensor storage unit recited in claim 15, wherein the optically-transparent and flexible material from which said chamber cover is manufactured is Plexiglass.

17. The tire pressure sensor storage unit recited in claim 13, further comprising a cover support mounted over said chamber cover to prevent said chamber cover from expanding so as to explode in response to the pressurization of said storage unit.

18. The tire pressure sensor storage unit recited in claim 17, wherein said cover support has an open window fanned therethrough so that the signal transmitted by said tire pressure sensor received within said storage chamber is transmitted through said chamber cover to the computer and the open window of said cover support mounted over said chamber cover.

19. The tire pressure sensor storage unit recited in claim 17, further comprising a gas supply valve extending through said chamber cover and said cover support mounted thereover so that said valve communicates with the storage chamber of said storage unit for supplying a gas to said storage chamber to thereby pressurize said storage unit and said tire pressure sensor received therewithin.

20. The tire pressure sensor storage unit recited in claim 17, further comprising fasteners detachably connected to said cover support, said chamber cover, and said storage chamber so that said chamber cover is sandwiched between said cover support and said storage chamber.
